(19) United States
(12) Patent Application Publication
(10) Pub. No.: US 2010/0174657 A1
(43) Pub. Date: Jul. 8, 2010

(54) SYSTEM AND METHOD FOR APPRAISAL INFORMATION SERVICES

(75) Inventor: MICHAEL J. STANTON, JR., Washington, DC (US)

Correspondence Address: MCGUIREWOODS, LLP, 1750 TYSONS BLVD, SUITE 1800, MCLEAN, VA, 22102, US

(73) Assignee: National Automobile Dealers Association, McLean, VA (US)

(21) Appl. No.: 12/649,934

(22) Filed: Dec. 30, 2009

Related U.S. Application Data
(60) Provisional application No. 61/141,384, filed on Dec. 30, 2008.

(51) Int. Cl. G06Q 50/00; G06F 17/30

(52) U.S. Cl. 705/306; 707/802; 707/770; 707/E17.044; 707/E17.014; 707/769; 707/E17.032

(57) ABSTRACT

A method for providing appraisal reference information from a computer based system includes receiving description of a target item for appraisal in the system, defining a geographic area for the appraisal in the system, searching price information of the target item within the geographic area based on the description of the target item in the system, and generating appraisal reference information for the target item based on the price information in the system.

### CROSS REFERENCE TO PRIOR APPLICATION

This application claims priority and the benefits thereof from U.S. Provisional Application No. 61/141,384, filed on Dec. 30, 2008, which is incorporated by reference as set forth herein in its entirety.

### FIELD OF THE DISCLOSURE

The disclosure relates to appraisal reference information services, more particularly to a method and a system for providing appraisal reference information.

### BACKGROUND OF THE DISCLOSURE

Typically when appraising the value of certain items, for example vehicles, it is necessary to review data from multiple sources. This requires the person that is conducting the appraisal to conduct multiple searches on multiple databases or manually look-up numerous different sources of information in order to help generate an accurate appraisal of the value of a certain piece of merchandise. This can be time consuming and inconvenient and can moreover lead to errors in a determination of the most accurate appraisal value.

Accordingly, a system that combines a plurality of databases and other information sources into a single search query and provides the information in a useful manner is needed in order to allow the appraiser to quickly, easily, and accurately determine a value for a certain piece of merchandise, such as a vehicle.

### SUMMARY OF THE DISCLOSURE

According to an aspect of the disclosure, a method for providing appraisal reference information from a computer based system includes receiving description of a target item for appraisal in the system, defining a geographic area for the appraisal in the system, searching price information of the target item within the geographic area based on the description of the target item in the system, and generating appraisal reference information for the target item based on the price information in the system.

The method may further include collecting price information of items and storing the collected price information of the items in a database. The searching the price information of the target item may include at least one of searching the database to retrieve the price information of the target item and obtaining the price information from an external data source.

The searching the price information of the target item may include at least one of searching advertised asking prices of items in a database that match the description of the target item within the geographic area, searching retail transaction prices of items in a database that match the description of the target item within the geographic area, searching wholesale transaction prices of items in a database that match the description of the target item within the geographic area, searching guidebook values of the target item in a database within the geographic area, and searching a popularity of the target item in a database within the geographic area.

The searching the advertized prices may include searching at least one of newspaper, magazine and Internet sources. The searching the popularity of the item may include comparing a measure of aggregate inventory of the similar items to a selling rate of the similar items in the geographic area.

The searching the price information may include searching databases for the advertised asking prices, the retail transaction prices, and the wholesale transaction prices of the items that match the description of the target item within the geographic area, searching the guidebook values of the target item within the geographic area and searching the popularity of the target item within the geographic area.

The appraisal reference information for the target item may include an average advertised asking price of the items that match the description of the target item within the geographic area, an average retail transaction price of the items that match the description of the target item within the geographic area, an average wholesale transaction price of the items that match the description of the target item within the geographic area, the guidebook value of the item within the geographic area, and the popularity of the item within the geographic area.

The target item may include at least one of a product and a service. The target item may include a used vehicle, and the description may include at least one of a vehicle identification number (YIN), a year, a make, a model, a trim, a condition, vehicle options, and a history of the used vehicle.

According to another aspect of the disclosure, a system for providing appraisal reference information includes a network, a user device connected to the network to send description data of a target used vehicle for appraisal, a database storing price information of a plurality of used vehicles, and a server connected to the network to receive the description data of the target used vehicle from the user device. The server is connected to the database to search price information of the target used vehicle within a defined geographic area based on the description data received from the user device and configured to generate appraisal reference information for the target used vehicle based on the price information.

The description data may include at least one of a vehicle identification number (VIN), a year, a make, a model, a trim, a condition, vehicle options, and a history of the used vehicle.

The network may include at least one of the Internet, a cellular data network, a local area network (LAN), a wide area network (WAN), a metropolitan area network (MAN), a personal area network (PAN), a campus area network, a corporate area network, a global area network, and a broadband area network (BAN).

The system may further include an external data source, and the server may be configured to search at least one of the databases and the external data source to search the price information of the target used vehicle within the defined geographic area.

The price information of the target used vehicle may include at least one of advertised asking prices of used vehicles that match the description of the target used vehicle within the geographic area, retail transaction prices of used vehicles that match the description of the target used vehicle within the geographic area, wholesale transaction prices of used vehicles that match the description of the target used vehicle within the geographic area, guidebook values of the target used vehicle within the geographic area, and a popularity of the target used vehicle within the geographic area.

The price information of the target used vehicle may include the advertised asking prices, the retail transaction prices and the wholesale transaction prices of the plurality of used vehicles that match the description of the target used vehicle within the geographic area, and the guidebook value and the popularity of the target used vehicle within the geographic area.

The appraisal reference information for the target used vehicle may include at least one of an average advertised asking price of the used vehicles that match the description of the target used vehicle within the geographic area, an average retail transaction price of the used vehicles that match the description of the target used vehicle within the geographic area, an average wholesale transaction price obtained from the used vehicles that match the description of the target used vehicle within the geographic area, the guidebook value of the target used vehicle within the geographic area, and the popularity of the target used vehicle within the geographic area.

The advertised asking prices stored in the database may be collected from at least one of newspaper, magazine, and the Internet. The server may be further configured to determine the popularity of the target used vehicle based on a measure of aggregate inventory and a selling rate of a plurality of used vehicles that match the description of the target used vehicle in the geographic area.

Additional features, advantages, and embodiments of the disclosure may be set forth or apparent from consideration of the detailed description and drawings. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a conceptual overview of an appraisal reference information service system constructed according to the principles of the disclosure;

FIG. 2 shows another conceptual overview of the appraisal reference information service system shown in FIG. 1 constructed according to the principles of the disclosure;

FIG. 3 shows a flowchart of a process for conducting an appraisal reference information service according to the principles of the disclosure;

FIG. 4 shows a flowchart of a process for searching price information of an item for appraisal according to the principles of the disclosure; and

FIG. 5 shows a flow chart of a process for providing appraisal reference information according to the principles of the disclosure.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

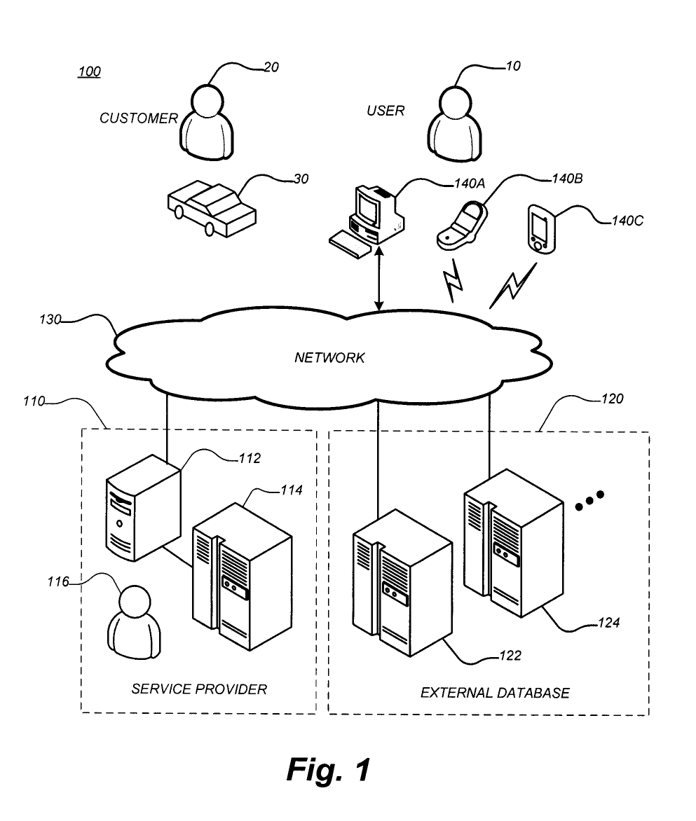

FIG. 1 shows a conceptual overview of an appraisal reference information service system 100 constructed according to the principles of the disclosure. The system 100 may include a service provider 110, external database 120, a network 130, one or more remote user devices 140, and or the like. The service provider 110 may include a server 112, internal database 114, and/or the like. The service provider 100 may be operated and maintained by one or more persons 116, such as, e.g., data collectors, system engineers, IT administrators, customer service personnel, and/or the like. The server 112 may include, for example, any combination of software and/or hardware, including at least one application and/or at least one computer to perform services for connected clients as part of a client-server architecture. At least one server application may include, but is not limited to, for example, an application program that may accept connections to service requests from clients by sending back responses to the clients.

The server 112 may be configured to run the at least one application, often under heavy workloads, unattended, for extended periods of time with minimal human direction. The server 112 may include a plurality of computers configured, with the at least one application being divided among the computers depending upon the workload. For example, under light loading, the at least one application can run on a single computer. However, under heavy loading, multiple computers may be required to run the at least one application. The server 112, or any of its computers, may also be used as a workstation.

The internal database 114 may be on-site and/or remotely located. In other words, any database that is owned, operated, and/or administered by the service provider 110 may be considered as the internal database 114 regardless of the physical location. The server 112 and the internal database 114 may be connected to the network 130. The external database 120 may be connected to the service provider 110 via the network 130. The external database 120 may or may not be owned, operated and/or administered by the service provider 110, but the contents thereof may be accessed, searched, and/or modified by the service provider 110. The external database 120 may be complementary to the internal database 114 of the service provider 110. Thus, the system 100 may not necessitate the external database 120 when the internal database 114 is sufficient. Alternatively, the service provider 110 may include no internal database and may fully rely on the external database 120.

The internal database 114 and/or the external database 120 may include a structured collection of records or data organized according to a database model, but not limited to at least one of a relational model, a hierarchical model, a network model, or the like. The server 112 may further include a database management system application (DBMS) as is known in the art. The internal database 114 and/or the external database 120 may include, for example, any combination of software and/or hardware, including at least one application and/or at least one computer. The internal database 114 and/or the external database 120 may include a structured collection of records or data organized according to a database model, but not limited to at least one of a relational model, a hierarchical model, a network model, or the like.

The internal database 114 and/or the external database 120 may include a database management system application (DBMS) as is known in the art. The at least one application may include, but is not limited to, for example, an application program that can accept connections to service requests from clients by sending back responses to the clients. The internal database 114 and/or the external database 120 may be configured to run the at least one application, often under heavy workloads, unattended, for extended periods of time with minimal human direction.

The network 130 may be any one or more of the Internet, a cellular data network, a local area network (LAN), a wide area network (WAN), a metropolitan area network (MAN), a personal area network (PAN), a campus area network, a corporate area network, a global area network, a broadband area network (BAN) and or the like, any of which may be configured to communicate data via a wireless and/or a wired communication medium. The user devices 140 may be any electronic device capable of establishing data communication between the user 10 and the service provider 110 via the network 130. The remote user devices 140 may be configured to accept data, perform prescribed mathematical and logical operations, and output the results of these operations. For example, the user devices 140 may be a computer 140A (e.g., a desktop computer, a laptop computer, a mobile computer or the like), a mobile telephone 140B (e.g., a cellular phone, a smartphone, a satellite phone, user equipment, mobile station or the like), a personal data assistant (PDA) 140C and the like.

The system 100 may be configured to provide a user 10 with appraisal reference information, which may help the user 10 provide more objective and accurate appraisal. The user 10 may be a buyer of an item 30. The user 10 may be an appraiser who is retained by a customer 20 to appraise an item 30. The customer 20 may be the current owner or a stake holder of the item 30. Alternatively, the user 10 may be the current owner or stake holder of the item 30, or anyone who wants the appraisal reference information for the item 30. The item 30 may be a product (e.g., a used vehicle, a used yacht, a used musical instrument, a used firearm, a used electronic device, used furniture, or the like), a collection (e.g., an art collection, an antique collection or the like), a pet, a livestock, a service, or the like.

The system 100 may receive item description data of the item 30 from the user 10, the customer 20 and/or a third party. For example, the user 10 may use the user device 140 to send the item description data of the item 30 to the service provider 110 via, e.g., the network 130. The item description data may be any type of data that allows the service provider 110 to search the internal database 114, the external database 120, and/or one or more external sources to obtain price information of the item 30. The more comprehensive the item description data is, the more accurate price information may be obtained. The user 10 and/or the service provider 110 may customize the searches. For example, the searches may be limited to a specific geographic area (e.g., city, state, metropolitan area, radius, postal codes, and/or the like) and/or a specific time period (e.g., last one week, last one month and/or the like).

In an embodiment, the item 30 is a used vehicle, and the item description data may include a vehicle identification number (VIN), a year, a make, a model, a trim, a track record, a condition, the options, color, mileage, and/or the like. The item description data may further include modification, customization, reconditioning and/or the like previously performed to the used vehicle 30. The VIN is a unique serial number used by the automotive industry to identify individual motor vehicles. As known in the art, the service provider 110 may obtain partial or complete item description data of the used vehicle 30 based on the VIN thereof. The service provider 110 may also obtain a track record of the used vehicle 30, such as, e.g., a vehicle history report, to identify any collision damage, improper vehicle maintenance, abnormality (e.g., vehicle title branding, lemon law buybacks, odometer fraud, recalls, and/or the like) and/or the like.

Based on the item description data, the server 112 may search the internal database 114, the external database 120, and/or one or more external sources to find price information of the used vehicle 30. To make the price information readily available for searches, the internal and/or external databases 114, 120 may be constantly updated with newly available price data of used vehicles of different makes, years, models, trims, conditions and/or the like. However, certain price information may not be readily available from the internal and external databases 114, 120 and only available from an external source. For example, it may be difficult to collect and maintain track records of all the vehicles in the U.S. In such a case, the service provider 120 may obtain the track record for the used vehicle 30 from the external source, such as, e.g., AutoCheck™, if necessary.

The price information may be a collection of relevant data obtained from the searches based on the item description data. For example, the price information may include at least one of advertised asking prices, retail transaction prices, wholesale transaction prices, guidebook values, and a popularity within a geographic area. In one aspect, the price information may include all of the advertised asking prices, the retail transaction prices, the wholesale transaction prices, the guidebook values and the popularity within the geographic area.

The advertised asking prices may be a collection of prices advertised in various media sources (e.g., newspaper, television, radio, magazine, the Internet, and/or the like) for used vehicles that match the item description data of the used vehicle 30 within the geographic area. The retail transaction prices may be a collection of prices at which used vehicles that match the item description data of the used vehicle 30 have been sold by retailers (e.g., used car dealers and/or the like) within the geographic area. The wholesale transaction prices may be a collection of prices at which used vehicles that match the item description data of the used vehicle 30 have been sold by wholesalers (e.g., auctioneers and/or the like) within the geographic area. The guidebook values may be a collection of prices listed in one or more used vehicle price guide publications, used vehicle price guide websites (e.g., www.nada.com/b2b and/or the like) and/or the like for the used vehicle 30 based on the current condition (e.g., excellent, average, rough or the like) thereof. The popularity may be an indication of how popular used vehicles that match the item description data of the used vehicle 30 have recently been, such as, e.g., high demand/high supply, high demand/low supply, low demand/high supply, low demand/low supply, and/or the like. For example, the popularity may be derived from comparing a measure of aggregate inventory to a selling rate of the used vehicles that match the item description data of the used vehicle 30 within the geographic area.

The service provider 110 may process the price information to produce appraisal reference information for the used vehicle 30. The appraisal reference information may include at least one of an average advertised asking price, an average retail transaction price, an average wholesale transaction price, a guidebook value, the popularity of the used vehicle 30 and/or the like. In one aspect, the appraisal reference information may include the average advertised asking price, the average retail transaction price, the average wholesale transaction price, the guidebook value, and the popularity, which are also referred to as five data points. The average advertised asking price may be an average price of the advertised asking prices within the geographic area. The average retail transaction price may be an average price of the retail transaction prices within the geographic area. The average wholesale transaction price may be an average price of the wholesale transaction prices within the geographic area. The guidebook value may be one of the guidebook values selected based on the condition of the used vehicle 30 within the geographic area.

The appraisal reference information may be sent to the user device 140 via the network 130. The appraisal reference information may help the user 10 to appraise the used vehicle 30 more accurately and objectively. Since much of the necessary information for appraising the used vehicle 30 has been collected and processed by the system 100, the user 10 may no longer need to conduct any searches to appraise the used vehicle 30. Thus, it may take a less time to appraise the used vehicle 30.

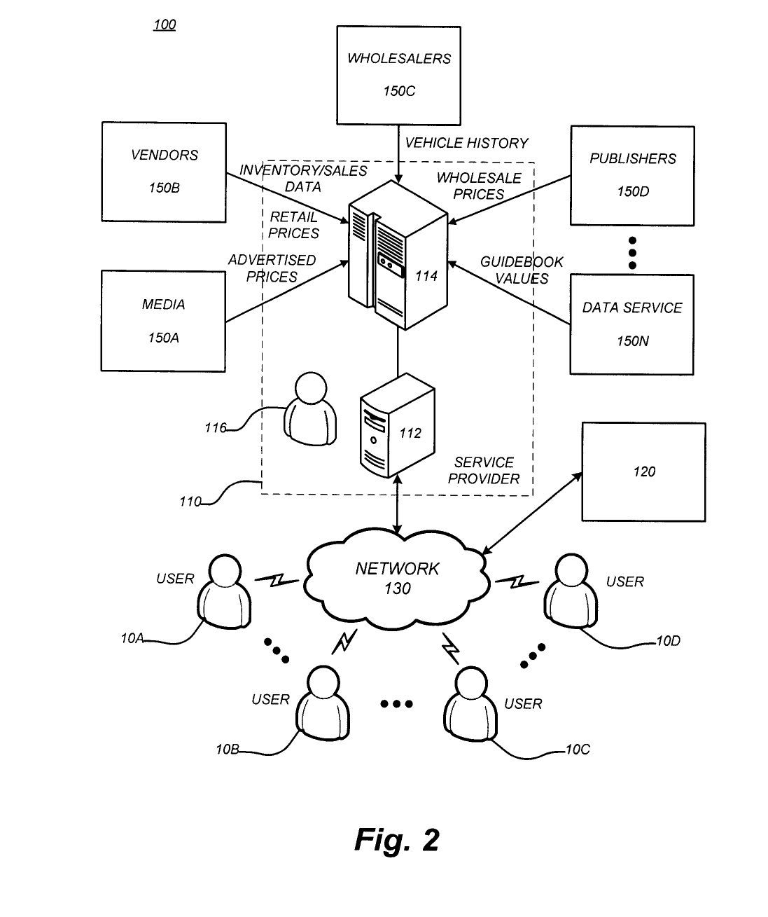

FIG. 2 shows another overview of the appraisal reference information service system 100 shown in FIG. 1 constructed according to the principles of the disclosure. The system 100 may be configured such that a plurality of users 10A, 10B, 10C, 10D located in different geographic areas can simultaneously access the system 100 via the network 130. In order to serve the users 10A, 10B, 10C, 10D with different locations, the service provider 110 may collect price information of used vehicles of different makes, years, models, trims, conditions and/or the like and store the collected price information to database, such as, e.g., the internal database 114, the external database 120 and/or the like). Additionally, the service provider 110 may be configured to spontaneously search external data sources (e.g., vendor/wholesaler sales database, media database, publisher database, vehicle history database, the Internet and/or the like) to obtain necessary price information.

The service provider 110 may collect price information from media 150A (e.g., newspaper, television, radio, magazine, the Internet and/or the like), vendors 150B (e.g., used car dealers and/or the like), wholesalers 150C (e.g., used vehicle auctioneers and/or the like), publishers 150D (e.g., guidebook publishers, price guide websites and/or the like) and data service companies 150N (e.g., vehicle history data company and/or the like). For example, the service provider 110 may collect advertised asking prices from the media 150A, retail transaction prices and inventory/sales data from the vendors 150B, whole sale prices from the wholesalers 150C, guidebook values from the publishers 150D. Further, the service provider 110 may obtain vehicle histories from the data service companies 150N. Thus, the system 100 may provide comprehensive appraisal reference information to the users 10A, 10B, 10C, 10D regardless of the locations.

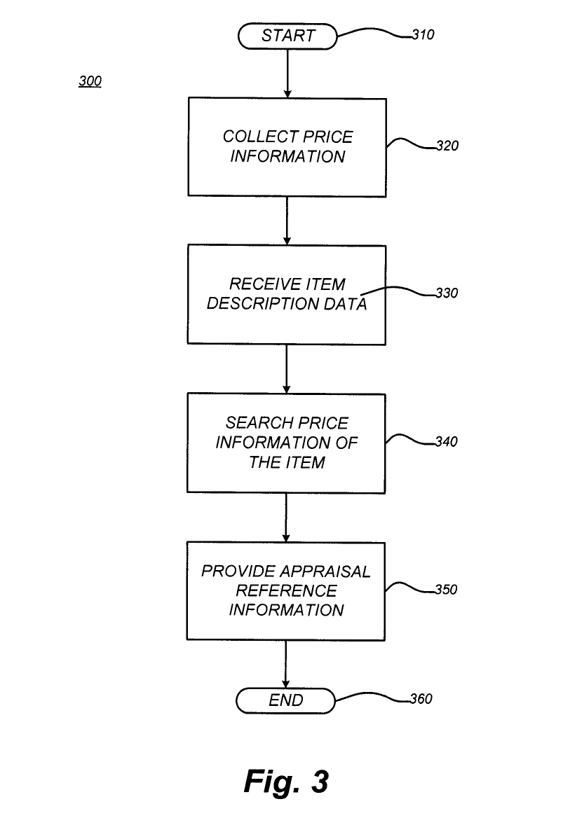

FIG. 3 shows a flowchart of a process 300 for conducting an appraisal reference information service according to the principles of the disclosure. With reference to the system 100 shown in FIGS. 1 and 2, upon starting the process 300 (at 310), price information of used vehicles may be collected (at 320) and stored in one or more databases (e.g., internal database 114, external database 120 and/or one or more external data sources 150A-150N). Once price information is stored in the databases, the service provider 110 may receive item description data of the used vehicle 30 from the user 10 (at 330). As noted above, the item description data may include a VIN, a year, a make, a model, a trim, a track record, a condition and/or the like. The service provider 110 may also receive geographical and/or time search limitations from the user 10. Based on the item description data, the service provider 110 may search the databases 114, 120 and/or one or more external data sources (e.g., media 150A, vendors 150B, wholesalers 150C, publishers 150D, data service companies 150N and/or the like) to collect price information of the used vehicle 30 (at 340). The price information may include at least one of advertised asking prices, retail transaction prices, wholesale transaction prices, guidebook values, and a popularity of the used vehicle 30 within the geographic area. Based on the collected price information, the service provider 110 may provide appraisal reference information to the user 10 (at 350). As noted above, the appraisal reference information may include at least one of an average advertised asking price, an average retail transaction price, an average wholesale transaction price, a guidebook value, the popularity and/or the like. Upon providing the appraisal reference information to the user 10, the process 300 may terminate (at 360).

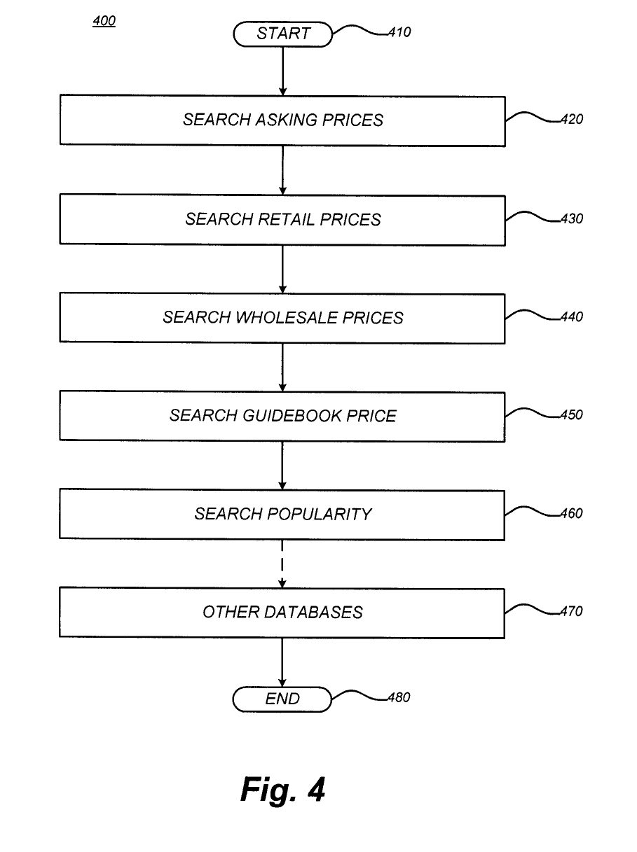

FIG. 4 shows a flowchart of a process 400 for searching price information according to the principles of the disclosure. With reference to the system 100 shown in FIGS. 1 and 2, the process 400 may start (at 410) after, for example, the service provider 110 receives the item description data of the used vehicle 30 from the user 10. Based on the item description, the service provider 110 may search the internal databases 114, the external database 120 and/or one or more external data sources to search advertised asking prices (at step 420), to search retail transaction prices (at 430), to search wholesale transaction prices (at 440), to search guidebook values (450) and to search a popularity of the used vehicle 30 (at 460) and other known databases 470. Thereafter, the process 400 may terminate (at 480).

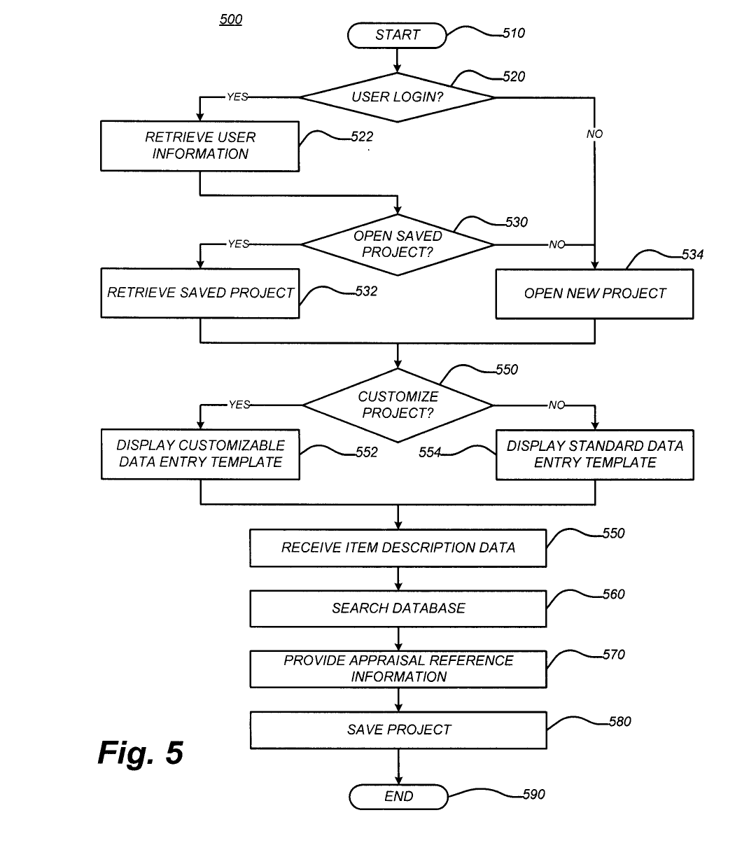

FIG. 5 shows a flow chart of a process 500 for providing appraisal reference information according to the principles of the disclosure. The process 500 may be implemented as a Web-based appraisal reference information service. With reference to the system 100 shown in FIGS. 1 and 2, the process 500 may start (at 510) when, for example, the user 10 visits a website offered by the service provider 110 using the user device 140. When the user 10 does not have an account with the service provider 110, the user 10 may not able to login (No, at 520). However, the user may be still allowed to open a new project (at 534) such that the user 10 may be provided with appraisal reference information of a used vehicle. When the user has an account with the service provider 110, the user may login to the website (YES, at 520) and user information may be retrieved (at 522) from the database 114. The user information may include personal information, such as, e.g., a name, an address, a telephone number, an email address, and/or the like. The user information may further include user preferences, such as, e.g., geographical search limitations (e.g., city, metropolitan area, state, postal codes, radius, and/or the like), time search limitations (e.g., one week, one month, one year or the like), associated dealers and/or the like. The service provider 110 may store completed and uncompleted projects previously saved by the user 10. When the user 10 wants to open a saved project (YES, at 530), for example, to continue an uncompleted project, the saved project may be retrieved (at 532) from the database 114. However, if the user 10 does not want to open a saved project (NO, at 530), a new project may be opened (at 534).

Once a saved project is retrieved (at 532) or a new project is opened (at 534), the user may choose whether or not to customize the project (at 550). A project may need to be customized when, for example, aftermarket modification has been previously performed to the used vehicle 30. When the user 10 chooses not to customize the project, a standard data entry template may be displayed on the user device 140 such that the user 10 may enter the item description data of the used vehicle 30. The standard data entry template may be a web page that includes buttons, drop-down menus, check boxes, text boxes, and/or the like. For example, the standard data entry template may include a text box for entering the VIN of the used vehicle 30, a drop-down menu for selecting the year, make, model, trim, condition and/or the like of the used vehicle 30, and/or the like.

The standard data entry template may display one or more presets based on the user preferences. For example, the standard data entry template may include check boxes and/or a drop-down menu for limiting searches to a specific geographic area, such as, e.g., city, states, metropolitan area, postal codes, radius and/or the like, and one of the check boxes or drop-down menu may be checked or selected by default based on the user preferences. The standard data entry template may further include check boxes and/or a drop-down menu for limiting the searches to a certain time period, such as, e.g., one week, one month, one year, or the like.

When the user 10 decides to customize the project (YES, 550), a customizable data entry template may be displayed on the user device 140 (at 552). Similar to the standard data entry template, the customizable data entry template may be a web page that includes buttons, drop-down menus, check boxes, text boxes and/or the like. However, the customizable data entry template may further include more buttons, drop-down menus, check boxes, text boxes and/or the like such that the user 10 can enter non-standard item description data, such as, e.g., aftermarket modification and/or the like.

Once the user 10 completes entering the item description data to the standard or customized data entry template, the item description data may be sent from the user device 140 and received by the service provider 110 (at 550) via the network 130. Based on the received item description data, the internal database 114, the external database 140 and/or one or more external data source 150A-150N may be searched (at 560) to collect price information of the used vehicle 30. As noted above, the price information may include advertised asking prices, retail transaction prices, and wholesale transaction prices of used vehicles that match the item description data of the used vehicle 30 within the geographic area, the guidebook values, and the popularity of the used vehicle 30 within the geographic area and/or the like.

The service provider 110 may process the collected price information 30 to obtain appraisal reference information for the used vehicle 30, and the appraisal reference information may be transmitted to the user device 140 (at 570). As noted above, the appraisal reference information may include at least one of an average advertised asking price, an average retail transaction price, an average wholesale transaction price, a guidebook value, the popularity of the used vehicle 30 and/or the like. The appraisal reference information may help the user 10 to appraise the used vehicle 30 more accurately and objectively in a shorter period of time without needing to conduct any further searches. Once the appraisal reference information is provided to the user 10 (at 570), the project may be saved (at 580) for future reference and the process 500 may end (at 590).

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications, or modifications of the disclosure.

What is claimed is:

1. A method for providing appraisal reference information from a computer based system comprising:
receiving description of a target item for appraisal in the system;
defining a geographic area for the appraisal in the system;
searching price information of the target item within the geographic area based on the description of the target item in the system; and
generating appraisal reference information for the target item based on the price information in the system.

2. The method of claim 1, further comprising:
collecting price information of a plurality of items; and
storing the collected price information of the plurality of items in a database.

3. The method of claim 2, wherein the searching the price information of the target item comprises at least one of:
searching the database to retrieve the price information of the target item; and
obtaining the price information from an external data source.

4. The method of claim 1, wherein the searching the price information of the target item comprises at least one of:
searching advertised asking prices of a plurality of items in a database that match the description of the target item within the geographic area;
searching retail transaction prices of a plurality of items in a database that match the description of the target item within the geographic area;
searching wholesale transaction prices of a plurality of items in a database that match the description of the target item within the geographic area;
searching guidebook values of the target item in a database within the geographic area; and
searching a popularity of the target item in a database within the geographic area.

5. The method of claim 4, wherein the searching the advertized prices comprises searching at least one of newspaper, magazine and Internet sources.

6. The method of claim 4, wherein the searching the popularity of the item comprises comparing a measure of aggregate inventory of the similar items to a selling rate of the similar items in the geographic area.

7. The method of claim 4, wherein the searching the price information comprises:
searching databases for the advertised asking prices, the retail transaction prices, and the wholesale transaction prices of the plurality of items that match the description of the target item within the geographic area;
searching the guidebook values of the target item within the geographic area; and
searching the popularity of the target item within the geographic area.

8. The method of claim 7, wherein the appraisal reference information for the target item comprises:
an average advertised asking price of the plurality of items that match the description of the target item within the geographic area;
an average retail transaction price of the plurality of items that match the description of the target item within the geographic area;
an average wholesale transaction price of the plurality of items that match the description of the target item within the geographic area;
the guidebook value of the item within the geographic area; and
the popularity of the item within the geographic area.

9. The method of claim 1, wherein the target item comprises at least one of a product and a service.

10. The method of claim 9, wherein the target item comprises a used vehicle.

11. The method of claim 10, wherein the description comprises at least one of a vehicle identification number (VIN), a year, a make, a model, a trim, a condition, vehicle options, and a history of the used vehicle.

12. A system for providing appraisal reference information, comprising:
a network;
a user device connected to the network to send description data of a target used vehicle for appraisal;
a database storing price information of a plurality of used vehicles; and
a server connected to the network to receive the description data of the target used vehicle from the user device, connected to the database to search price information of the target used vehicle within a defined geographic area based on the description data received from the user device and configured to generate appraisal reference information for the target used vehicle based on the price information.

13. The system of claim 12, wherein the description data comprises at least one of a vehicle identification number (VIN), an year, a make, a model, a trim, a condition, vehicle options, and a history of the used vehicle.

14. The system of claim 12, wherein the network comprises at least one of the Internet, a cellular data network, a local area network (LAN), a wide area network (WAN), a metropolitan area network (MAN), a personal area network (PAN), a campus area network, a corporate area network, a global area network, and a broadband area network (BAN).

15. The system of claim 12, further comprises an external data source, wherein the server is configured to search at least one of the databases and the external data source to search the prices information of the target used vehicle within the defined geographic area.

16. The system of claim 12, wherein the price information of the target used vehicle comprises at least one of:
advertised asking prices of a plurality of used vehicles that match the description of the target used vehicle within the geographic area;
retail transaction prices of a plurality of used vehicles that match the description of the target used vehicle within the geographic area;
wholesale transaction prices of a plurality of used vehicles that match the description of the target used vehicle within the geographic area;
guidebook values of the target used vehicle within the geographic area; and
a popularity of the target used vehicle within the geographic area.

17. The system of claim 16, wherein the advertised asking prices stored in the database are collected from at least one of newspaper, magazine, and the Internet.

18. The system of claim 16, wherein the server is further configured to determine the popularity of the target used vehicle based on a measure of aggregate inventory and a selling rate of a plurality of used vehicles that match the description of the target used vehicle in the geographic area.

19. The system of claim 16, wherein the price information of the target used vehicle comprises the advertised asking prices, the retail transaction prices and the wholesale transaction prices of the plurality of used vehicles that match the description of the target used vehicle within the geographic area, and the guidebook value and the popularity of the target used vehicle within the geographic area.

20. The system of claim 19, wherein the appraisal reference information for the target used vehicle comprises at least one of:
an average advertised asking price of the plurality of used vehicles that match the description of the target used vehicle within the geographic area;
an average retail transaction price of the plurality of used vehicles that match the description of the target used vehicle within the geographic area;
an average wholesale transaction price obtained from the plurality of used vehicles that match the description of the target used vehicle within the geographic area;
the guidebook value of the target used vehicle within the geographic area; and
the popularity of the target used vehicle within the geographic area.
